(19) United States
(12) Patent Application Publication
(10) Pub. No.: US 2007/0249208 A1
(43) Pub. Date: Oct. 25, 2007

(54) PLUG-IN CONNECTOR FOR CONNECTING ELECTRONIC COMPONENTS

(75) Inventor: Juergen Lappoehn, Gammelshausen (DE)

Correspondence Address: DARBY & DARBY P.C., P.O. BOX 770, Church Street Station, New York, NY, 10008-0770, US

(73) Assignee: ERNI-ELEKTRO-APPARATE GMBH, Adelberg (DE)

(21) Appl. No.: 11/686,747

(22) Filed: Mar. 15, 2007

(30) Foreign Application Priority Data
Apr. 21, 2006 (DE) 102006019203.6

(51) Int. Cl. H01R 13/52

(52) U.S. Cl. 439/282

(57) ABSTRACT

A plug-in connector for connecting electronic components, comprising plug-in connector elements (100, 200; 300) adapted one to the other, especially multipoint pin connector elements and/or multipoint socket connector elements, having electric contacts (140, 240; 340) arranged in a substantially cuboid body, is characterized in that at least one shoulder (110; 310) is formed on at least one side wall (101; 301) of the body, in which grooves (120; 320) are defined at predeterminable defined points, which grooves extend in the plugging direction and, when the plug-in connector elements are correctly positioned, accommodate matching ribs (220, 320) of another plug-in connector element (200; 300) and, when incorrectly positioned, form an abutting surface for the ribs (220; 320).

The present invention relates to a plug-in connector for connecting electric components according to the preamble of claim 1.

### PRIOR ART

Plug-in connectors of that kind are used for connecting, for example, printed-circuit boards arranged one above the other, one printed-circuit board with an electronic component, or the like. Very frequently, plug-in connectors are multi-way plugs comprising two plug-in connector elements adapted one to the other, especially multipoint pin connector elements and multipoint socket connector elements that match each other. The plug-in connectors comprise a body of substantially cuboid shape. Electric contacts arranged inside the body serve for transmitting electric signals and pulses. In order to ensure that plug-in connectors can be connected in a single desired position only, the two plug-in connector elements must be provided with a coding and a counter-coding, respectively. Such a coding and counter-coding may consist, for example, of especially shaped openings directly in the connector housing, as described for example in DE 199 32 942 A1. Designing the plug-in connector elements as such in this way, however, complicates their production. In addition, it may happen in the case of such coding means, that if higher forces are applied the parts to be fitted one in the other, for example thin bridges that are part of the coding, may break off so that as a result undesirable contacts may be made.

Now, it is the object of the present invention to provide plug-in connectors of the kind described at the outset with a coding and counter-coding which can be produced very easily but which, on the other hand, will avoid faulty and undesirable plugging even when high forces are exerted on the plug-in connector elements.

### DESCRIPTION AND ADVANTAGES OF THE INVENTION

The invention achieves this object by a plug-in connector having the features defined in claim 1.

Using a shoulder arranged on one side wall of the body, in which grooves are defined at predeterminable defined points, which extend in the plugging direction and which, when correctly positioned, accommodate matching ribs of another plug-in connector element and, when incorrectly positioned, form an abutting surface for the ribs, any undesirable connection of the two connector elements is prevented.

Fitting the two plug-in connector elements one in the other is prevented by this arrangement on the one hand when the two plug-in connector elements do not belong to the same type of plug-in connector, but rather to different types of plug-in connectors, and also when the two plug-in connector elements, while belonging to the same plug-in connector, are incorrectly positioned one above the other, for example at an angle one relative to another. The way in which the two plug-in connector elements are positioned one above the other does not matter in this case. The coding, i.e. the arrangement of the ribs and grooves, makes it impossible in this case to plug the elements one into the other.

Providing such a shoulder especially makes any faulty connection of the two plug-in connector elements impossible, even if high forces are applied, because the shoulder will form a solid abutting surface in case the plug-in connector elements should be incorrectly positioned.

In principle, the shoulder and the side wall could enclose between them any desired angle. According to an especially advantageous embodiment, the angle enclosed between the shoulder and the side wall is a right angle. Using a right angle prevents any faulty connection of the plug-in connector elements particularly efficiently.

The ribs likewise may be formed in the most different ways, for example as ribs with a semi-cylindrical contour or as ribs with a polygonal contour. An especially advantageous embodiment uses a cuboid shape for the ribs. In addition to providing a coding, optimum guidance of the two plug-in connector elements one relative to the other is achieved especially when a plurality of ribs and grooves are provided in the plug-in connector elements.

According to one advantageous embodiment, the ribs are provided, on their side facing the shoulder, with a flat surface extending in parallel to the shoulder surface of the plug-in connector element. In case the plug-in connector element should be incorrectly positioned, those flat surfaces will abut against the shoulders. The abutting surfaces therefore prevent the two connector elements from being connected even if high forces should be applied.

The body preferably is made from a plastic material, especially as an injection-molded plastic part. That design not only facilitates the production process, but simultaneously serves electric insulating purposes.

In principle, the ribs on the second plug-in connector element may be attached as a separate component, for example by bonding, welding, or the like. An especially advantageous embodiment provides that the ribs are formed integrally on the second plug-in connector element. This makes production particularly easy, especially in cases where the plug-in connector element is produced as an injection-molded plastic part.

Further details, features and advantages of the invention are the subject of the specification that follows and are illustrated in the drawing showing certain embodiments of the invention.

### DRAWING

In the drawing:

FIGS. 1a, 1b show diagrammatic representations of two plug-in connector elements of different plug-in connector types, arranged in two different positions one above the other;

FIGS. 2a, 2b show a plug-in connector where a second plug-in connector element is arranged in different positions above the first plug-in connector element of the plug-in connector;

FIG. 3 shows a plug-in connector element of another embodiment of a plug-in connector using the invention;

FIG. 4 shows the arrangement of a second plug-in connector element of identical design above the first plug-in connector element illustrated in FIG. 3, with the second plug-in connector element correctly positioned relative to the first plug-in connector element;

FIG. 5 shows another embodiment of a plug-in connector using the invention, with a second plug-in connector element incorrectly positioned above a first plug-in connector element of identical design; and

FIG. 6 shows the plug-in connector illustrated in FIG. 5, with the second plug-in connector element sectioned in part.

### DESCRIPTION OF THE EMBODIMENTS

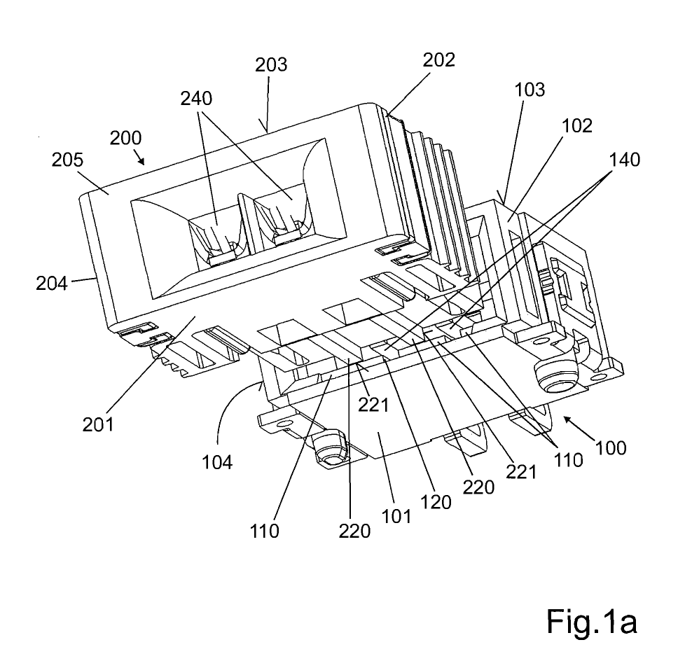

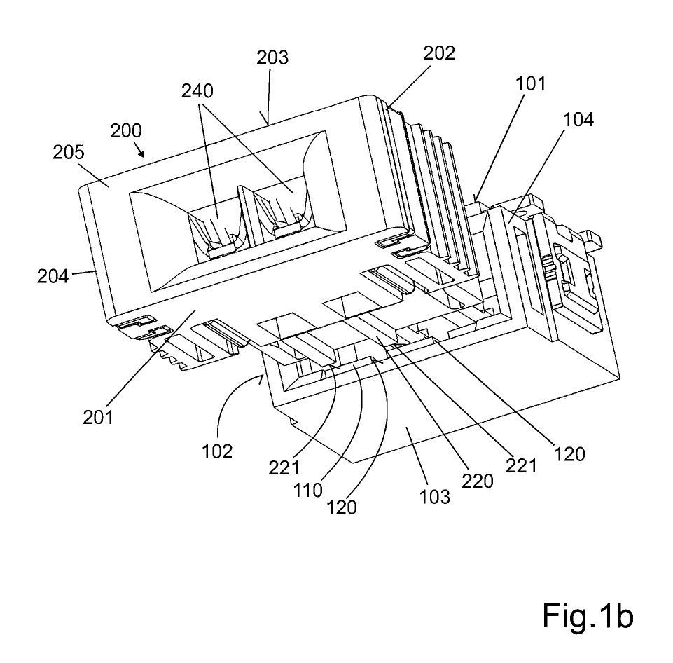

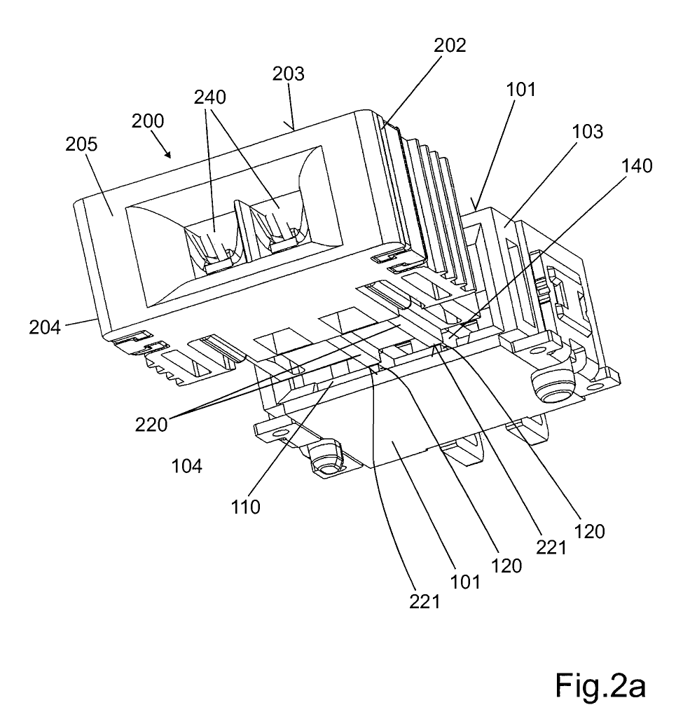

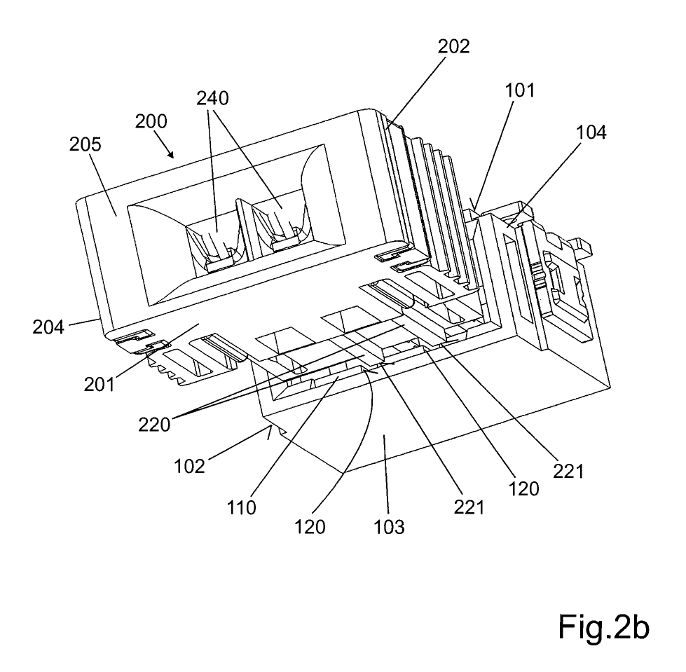

A plug-in connector illustrated in FIGS. 1 and 2 comprises a first plug-in connector element, indicated generally by reference numeral 100, and a second plug-in connector element, indicated generally by reference numeral 200. The first plug-in connector element 100 may be designed, for example, as a multipoint pin connector element, the second plug-in connector element 200 as a multipoint socket connector element that matches the multipoint pin connector element for producing a plug-in connection.

The first plug-in connector element 100 comprises a substantially cuboid body with side walls 101, 102, 103, 104, the second plug-in connector element 200 likewise comprises a substantially cuboid body with side walls 201, 202, 203, 204. Shoulders 110, in which grooves 120 extend substantially in the plugging direction, are formed on two preferably opposite side walls 101 and 103 of the body.

On the side wall 201 of the second plug-in connector element, ribs 220 are provided which match the grooves 120 and which likewise extend in the plugging direction. Both the grooves 120 and the ribs 220 have a cuboid cross-section in the illustrated embodiment.

FIG. 1 illustrates the case where it is attempted to connect the two plug-in connector elements 100, 200 that belong to different plug-in connectors and, therefore, must not be connected in any case. FIG. 1a shows the case where the second plug-in connector element 200, i.e. the multipoint socket connector element, is arranged above the first plug-in connector element 100, i.e. the multipoint pin connector element. As the two plug-in connector elements do not belong to the same plug-in connector, the ribs 220, being provided, on their side facing the shoulder 110, with end faces 220 that extend substantially in parallel to the shoulder surface, have their end faces 221 abutting against the shoulder 110. The shoulder 110 as such is arranged to project substantially at a right angle relative to the side wall 101 of the first plug-in connector element 100. Due to the end faces 221, extending in parallel to the shoulder 110, the two plug-in connector elements 100, 200 cannot be fitted one in the other when incorrectly positioned, not even with high force.

Even after rotation of the multipoint pin connector element, as illustrated in FIG. 1b, it is not possible to fit the second plug-in connector element 200, i.e. the multipoint socket connector element, in the first plug-in connector element 100 to thereby establish electric contact. The ribs 220 will in this case likewise come to abut against the shoulder 110 and will not fit into the groove 120, the two plug-in connector elements 100 belonging to different types of plug-in connectors. This arrangement therefore prevents the two elements from being fitted one in the other inadvertently.

FIGS. 2a, 2b illustrate plug-in connector elements 100, 200 which belong to a single plug-in connector and which therefore can be fitted one in the other when the second plug-in connector 200 is placed correctly above the first plug-in connector element 100 illustrated in FIG. 2a. In the case of the embodiment illustrated in FIG. 2, identical features of the two plug-in connector elements 100, 200 are indicated by the same reference numerals as used for the plug-in connector elements illustrated in FIG. 1. When the plug-in connector element 200 occupies the correct position above the first plug-in connector element 100, the ribs 220 engage into the grooves 120 and are guided in them. The two plug-in connector elements 100, 200 can be fitted in this case one in the other for establishing electric contact, the ribs 220 and the grooves 120 providing precise guidance for the plug-in connector elements 100, 200, due to their respective matching rectangular shapes, thereby guaranteeing a very safe and precise electric connection.

However, when the first plug-in connector element 100, i.e. the multipoint pin connector element is turned by 1800, as illustrated in FIG. 2b, fitting the two plug-in connector elements 100, 200 of the plug-in connector one in the other is impossible because in this case the ribs 220, being then in non-symmetrical alignment, do not fit into the grooves 120, but have their flat end faces 212 abutting against the shoulders 110.

In the plugged condition, the electric contact of the first plug-in connector element 100, in the form of pins 140, engage in the known manner in sockets of the second plug-in connector element 200, matching the pins 140. The second plug-in connector element 200 is provided, at its upper end face 205, with openings in which connection contacts 240 are arranged to which lines can be connected by crimping, for example.

Each of the two plug-in connector elements 100, 200 is made from a plastic material, preferably as an injection-molded plastic part, the second plug-in connector element 200 being provided with integrally formed ribs 220. Making the two plug-in connector elements 100, 200 as injection-molded plastic parts permits the coding and counter-coding to be varied very easily. It is merely necessary in this case to change the arrangement of the grooves 120 and the ribs 220 in the die to some extent.

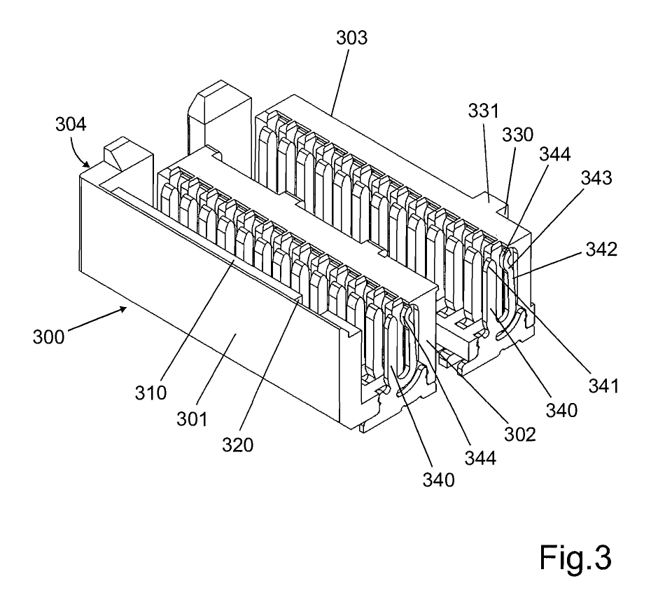

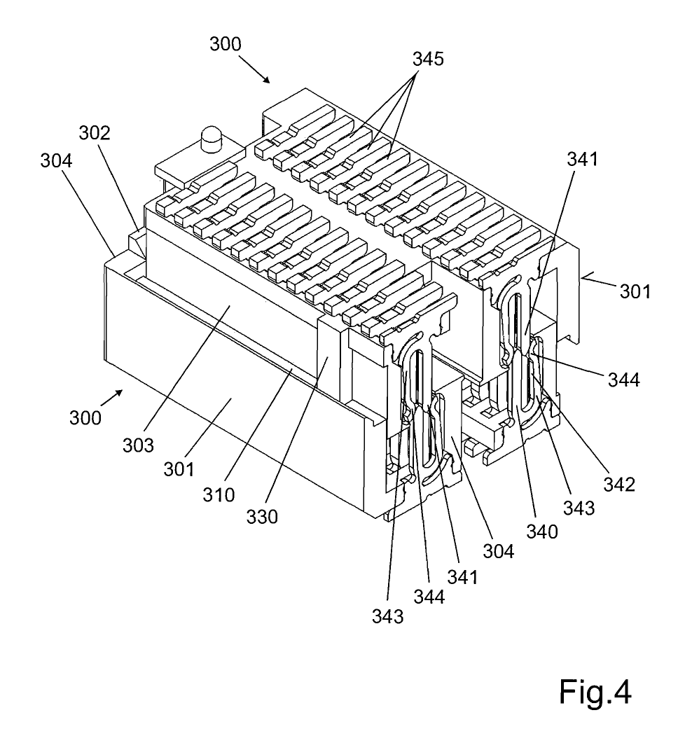

According to another embodiment, illustrated in FIG. 3 to FIG. 6, the two plug-in connector elements do not consist of a multipoint pin connector element and a multipoint socket connector element, but rather of a single component serving both as a multipoint pin connector element and as a multipoint socket connector element. Such a plug-in connector element, also known as [name], likewise comprises a substantially square body 300 with side walls 301, 302, 303, 304. In this case, the plug-in connector element 300 likewise consists of an injection-molded plastic part to which the electric contacts 340 are attached in the known way, for example by snapping them into place, by bonding, or the like. The contacts 340 as such are designed in this embodiment to simultaneously serve as multipoint pin connector elements and multipoint socket connector elements, the multipoint pin connector elements 341 being capable of engaging in an opening 342 when another plug-in connector element 300 of identical design is positioned “upside down” above the plug-in connector element 300, as illustrated diagrammatically in FIG. 4. While the multipoint pin connector elements 341 engage in this case in the openings 342, there is provided a second resilient contact 343 with a bulging portion 344 projecting from its upper end in substantially semicircular shape which, in the plugged condition of the plug-in connector elements, is in contact with the multipoint pin connector element 341 thereby forming the spring element. The contacts 340 are each provided with soldering surfaces 345 by means of which they can be fixed in electrically conductive condition for example on a printed-circuit board.

The plug-in connector element 300 is provided on one side wall 301 with a shoulder 310 preferably projecting at a right angle from the side wall 301. The shoulder 310 is interrupted by grooves 320 of cuboid shape. On the side wall 303 opposite that side wall 301, ribs 330 are provided which likewise exhibit a cuboid shape and are adapted to the grooves 320 so that they will engage the grooves 320 for being guided therein when a plug-in connector element 300 is correctly positioned upside down, i.e. with its contacts 341 pointing downward, above the plug-in connector element 300 illustrated in FIG. 1, as illustrated diagrammatically in FIG. 4. In contrast, when incorrectly positioned, the lower end faces 331 of the ribs 330, which extend in parallel to the shoulder 310, will abut against the shoulder 310 thereby forming an abutting surface that will withstand even high forces that may be exerted upon the two plug-in connector elements 300.

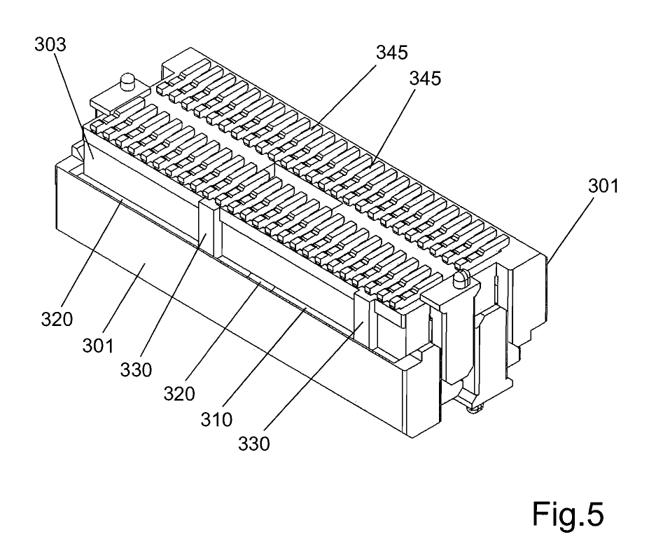

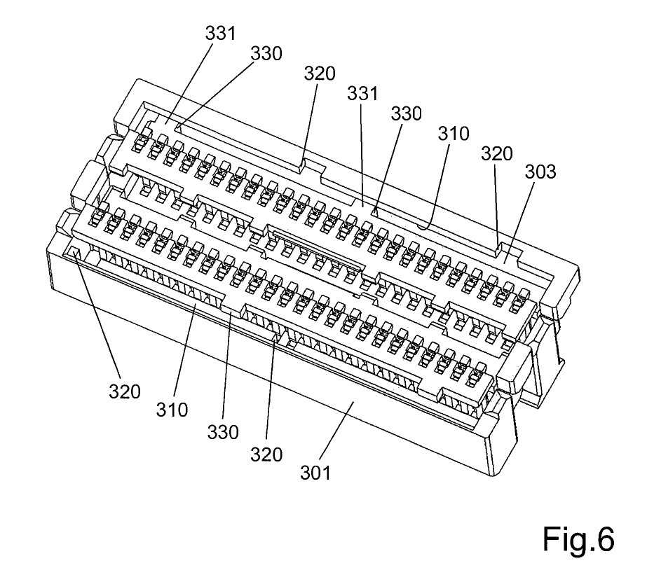

The plug-in connector illustrated in FIG. 5 and FIG. 6 corresponds to the plug-in connector illustrated in FIG. 3 and FIG. 4, except that it comprises a greater number of electric contacts 341. In the embodiment illustrated in FIG. 5 and FIG. 6, identical elements are designated by the same reference numerals as in the embodiment illustrated in FIG. 3 and FIG. 4 so that full reference is made to the above explanations with respect to that embodiment.

The plug-in connector illustrated in FIG. 5 and FIG. 6 differs from the embodiment illustrated in FIG. 3 and FIG. 4 in that two grooves 320 and ribs 330, respectively, are provided on each of the side walls.

FIG. 5 and FIG. 6 show the two plug-in connector elements arranged in incorrect alignment relative to the ribs 330 abutting in this case against the shoulders 310, as can be seen especially in the partly sectioned illustration of FIG. 6, so that the ribs 330 cannot engage the grooves 320 and the two plug-in connector elements 300 cannot be connected one with the other. In this case as well the ribs 330 are provided on their lower side, facing the shoulder 310, with end faces extending substantially in parallel to the shoulder surface 310 so that a large contact surface is obtained between the end faces of the ribs 330 and the shoulder 310 that prevents any undesirable and faulty connection from being made—even if high forces should be applied upon the two plug-in connector elements.

In all embodiments that have been described above, the grooves and the ribs are provided in non-symmetrical arrangement so that the plug-in connector elements of the same type of plug can be fitted one in the other in a single position only. Thus, the invention not only prevents plug-in connector elements belonging to different types of plugs from being fitted one in the other, but also excludes any undesirable connection of plug-in connector elements of the same type of plugs when the same are incorrectly positioned.

It should be noted that the invention is not limited to ribs and grooves of rectangular shape. In principle, the ribs and grooves may have any shape, including for example cylindrical shapes, polygonal shapes, or the like. Further, the arrangement of the shoulders 110, 310 is not limited to one where the shoulders project vertically to the side wall. In principle, it would also be possible to have them extend obliquely to the side wall, for example toward the top or toward the bottom. In this case, the lower end faces 221 321 should then advantageously be adapted to such oblique shoulders.

1. Plug-in connector for connecting electronic components, comprising plug-in connector elements adapted one to the other, especially multipoint pin connector elements and/or multipoint socket connector elements, having electric contacts arranged in a substantially cuboid body, characterized in that at least one shoulder is formed on at least one side wall of the body, in which grooves are defined at predeterminable defined points, which grooves extend in the plugging direction and, when the plug-in connector elements are correctly positioned, accommodate matching ribs of another plug-in connector element and, when incorrectly positioned, form an abutting surface for the ribs.

2. The plug-in connector as defined in claim 1, characterized in that the grooves and the ribs are each provided in non-symmetrical arrangement so that the plug-in connector elements can be fitted one in the other only in a single position of the plug-in connector elements.

3. The plug-in connector as defined in claim 1, characterized in that the at least one shoulder and the side wall enclose between them a right angle.

4. The plug-in connector as defined in claim 1, characterized in that the ribs have a semi-cylindrical or polygonal or a cuboid shape.

5. The plug-in connector as defined in claim 1, characterized in that the ribs are provided, on their side facing the at least one shoulder, with a flat end face that extends in parallel to the shoulder.

6. The plug-in connector as defined in claim 1, characterized in that the body is made from a plastic material.

7. The plug-in connector as defined in claim 6, characterized in that the body is an injection-molded plastic part.

8. The plug-in connector as defined in claim 1, characterized in that the at least one shoulder is formed integrally with and as part of the side wall.

9. The plug-in connector as defined in claim 1, characterized in that the ribs are formed integrally with and as part of the side wall.
